(19) United States
(12) Patent Application Publication
(10) Pub. No.: US 2022/0084693 A1
(43) Pub. Date: Mar. 17, 2022

(54) SYSTEMS AND METHODS FOR NUCLEAR FUSION

(71) Applicant: Aquarius Energy, Inc., Wilmington, DE (US)

(72) Inventors: John F. Dodaro, Wilmington, DE (US); Ralph A. Dalla Betta, Wilmington, DE (US); Ricardo B. Levy, Wilmington, DE (US)

(21) Appl. No.: 17/477,818

(22) Filed: Sep. 17, 2021

Related U.S. Application Data
(63) Continuation of application No. PCT/US2020/023216, filed on Mar. 17, 2020.
(60) Provisional application No. 62/821,244, filed on Mar. 20, 2019.

(51) Int. Cl. G21B 3/00

(52) U.S. Cl. CPC G21B 3/002; G21B 3/006

(57) ABSTRACT

The present disclosure provides methods and systems for generating heat from nuclear fusion. The methods and systems utilize host materials (such as metal nanoparticles) to host fusionable materials (such as deuterium). The host materials and/or fusionable materials are irradiated with electromagnetic radiation that induces phonon vibrations in the host material and/or fusionable materials. The phonon vibrations screen the Coulombic repulsion between fusionable material nuclei, thereby increasing a rate of nuclear fusion even at relatively low temperature and pressures. The methods and systems give rise to nuclear fusion reactions which produce energy or heat. The heat may be converted into useful energy using systems and methods for efficient heat dissipation and thermal management.

### CROSS-REFERENCE

This application is a Continuation Application of International Application No. PCT/US2020/023216, filed Mar. 17, 2020, which claims the benefit of U.S. Provisional Patent Application No. 62/821,244, filed Mar. 20, 2019, which is entirely incorporated herein by reference for all purposes.

### BACKGROUND

Existing approaches for power or heat, or for converting heat into useful energy, may be deficient in one or more aspects. For instance, such approaches may be inefficient, suffer from low energy densities, utilize non-abundant supplies of fuel, or produce detrimental effects for society, such as by emitting carbon dioxide, radioactive byproducts, or other pollutants or by posing a weapons proliferation risk.

### SUMMARY

Recognized herein is a need for methods and systems for providing power or heat, or for converting heat into useful energy in an efficient manner using nuclear fusion reactions.

The present disclosure provides methods and systems for nuclear fusion. The methods and systems may utilize host materials (such as metal nanoparticles) to host fusionable materials (such as deuterium). The host materials and/or fusionable materials may be irradiated with electromagnetic radiation that induces phonon vibrations in the host material and/or fusionable materials. The phonon vibrations may screen the Coulombic repulsion between fusionable material nuclei, thereby increasing a rate of nuclear fusion even at relatively low temperature and pressures. The methods and systems may give rise to nuclear fusion reactions which provide power or heat. The heat may be converted into useful energy.

In an aspect, the present disclosure provides a method for nuclear fusion comprising: (a) providing a chamber comprising a host material having a fusionable material coupled thereto; (b) providing electromagnetic radiation to the host material or the fusionable material in the chamber to generate oscillations within the host material or the fusionable material, which oscillations are sufficient to subject the fusionable material to a nuclear fusion reaction to yield energy in the chamber; and (c) extracting at least a portion of the energy from the chamber. The host material may comprise one or more members selected from the group consisting of: a metal, a metal hydride, a metal carbide, a metal nitride, and a metal oxide. The host material may comprise one or more particles comprising a characteristic dimension of at most about 1,000 nanometers (nm). The fusionable material may comprise one or more members selected from the group consisting of: hydrogen, deuterium, lithium, and boron. The oscillations may comprise lattice oscillations of one or more members selected from the group consisting of the host material and the fusionable material. The lattice oscillations may comprise coherent oscillations. The lattice oscillations may persist for at least about one oscillation period. The coherent oscillations may comprise phonon oscillations. The phonon oscillations may comprise harmonic phonon oscillations. The phonon oscillations may comprise parametric phonon oscillations. The coherent oscillations may comprise non-linear phonon oscillations. The coherent oscillations may comprise spatially localized oscillations. The electromagnetic radiation may comprise one or more frequencies between 1 terahertz (THz) and 50 THz. The electromagnetic radiation may comprise one or more frequencies corresponding to a fundamental, harmonic, or sub-harmonic lattice frequency or surface vibration frequency of the host material or the fusionable material or the fusionable material dissolved in the host material. The energy may comprise one or more members selected from the group consisting of heat, kinetic energy of charged particles, coherent oscillations, and kinetic motion of charged product nuclei. The method may further comprise containing the host material within a heat transfer material configured to extract the heat. The heat transfer material may comprise a thermal conductivity of at least about 1 Watt meters⁻¹ Kelvin⁻¹ (W m⁻¹ K⁻¹). The thermal conductivity may be at least about 1000 W m⁻¹ K⁻¹. The heat transfer material may comprise a material having a higher thermal conductivity region nearer to the host material and a lower thermal conductivity region further from the host material. The higher thermal conductivity region may comprise a porous medium thermal conductivity material. The heat transfer material may comprise one or more members selected from the group consisting of: carbon nanotubes (CNTs), single-walled CNTs, double-walled CNTs, multi-walled CNTs, graphite, graphene, diamond, zirconium oxide, aluminum oxide, and aluminum nitride. The method may further comprise containing the heat transfer material within a heat exchange fluid. The method may further comprise using the heat exchange fluid to drive a generator. The method may further comprise providing a system for generating temperature and pressure oscillations of the fusionable material in a gaseous form, which oscillations are sufficient to control a chemical activity at a surface of the host material.

In another aspect, a method for low-energy nuclear fusion may comprise: (a) catalytically inducing a low-energy nuclear fusion reaction in a fusionable material to yield energy; and (b) extracting at least a portion of the energy. The low-energy nuclear fusion reaction may comprise one or more intermediate reaction steps.

In another aspect, the present disclosure provides a system for nuclear fusion comprising: (a) a chamber comprising a host material having a fusionable material coupled thereto; (b) a source of electromagnetic radiation configured to generate oscillations within the host material or the fusionable material, which oscillations are sufficient to subject the fusionable material to a nuclear fusion reaction to yield energy in the chamber; and an energy extraction unit configured to extract at least a portion of the energy from the chamber.

Another aspect of the present disclosure provides a non-transitory computer readable medium comprising machine executable code that, upon execution by one or more computer processors, implements any of the methods above or elsewhere herein.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention will be obtained by reference to the following detailed description that sets forth illustrative embodiments, in which the principles of the invention are utilized, and the accompanying drawings (also “Figure” and “FIG.” herein), of which:

FIG. 1 shows an example of a fusion catalyst core comprising a nanoparticle of palladium with a face centered cubic structure.

FIG. 2 shows an example of a fusion catalyst core deposited inside a single wall carbon nanotube.

FIG. 3 shows an example of a fusion catalyst core deposited inside a multiwall carbon nanotube.

FIG. 4 shows an example of a fusion catalyst core deposited inside a multiwall carbon nanotube inside a coating of porous ceramic.

FIG. 5A shows an example of a growth process of carbon nanotubes on a flat substrate.

FIG. 5B shows an example of long carbon nanotubes forming a “forest” like structure on a flat structure.

FIG. 6 shows an example of a fusion catalyst core comprising a layer on a plate.

FIG. 7 shows an example of a thermal electric generation system using a fusion catalyst core configured to generate steam to drive a steam turbine.

FIG. 8 shows an example of a fusion catalyst core deposited as a layer on a heat exchanger surface configured to transfer heat to a heat transfer medium.

FIG. 9 shows an example of a primary battery design using deuterium fuel and a thermoelectric plate.

FIG. 10 shows an example of a thermal generation system comprising a flat plate reactor.

FIG. 11 shows a flowchart for an example of a method for nuclear fusion.

FIG. 12 shows a flowchart for an example of a method for low-energy nuclear fusion.

FIG. 13 shows a computer control system that is programmed or otherwise configured to implement methods provided herein.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

Whenever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

As used herein, like characters refer to like elements.

As used herein, the term “fusionable material” refers to any material having an atomic nucleus capable of undergoing nuclear fusion reactions. A fusionable material may comprise any material having an atomic nucleus with an atomic mass smaller than 56 atomic mass units (u). Fusionable materials include protons (hydrogen-1) ions (H⁺) or atoms (H₂), deuterium (hydrogen-2) ions (D⁺) or atoms (D₂), tritium (hydrogen-3) ions (T⁺) or atoms (T₂), helium-3 ions (e.g., ³He⁺) or atoms (³He), helium-4 ions (e.g., ⁴He⁺) or atoms (⁴He), lithium-6 ions (⁶Li⁺) or atoms (⁶Li), lithium-7 ions (⁷Li⁺) or atoms (Li), boron-10 ions (e.g., ¹⁰B⁺) or atoms (¹⁰B), boron-II ions (e.g., ¹¹B⁺) or atoms (¹¹B), carbon-12 ions (e.g., ¹²C⁺) or atoms (¹²C), carbon-13 ions (e.g., ¹³C⁺) or atoms (¹³C), nitrogen-13 ions (e.g., ¹³N⁺) or atoms (¹³N), nitrogen-14 ions (e.g., ¹⁴N⁺) or atoms (¹⁴N), and nitrogen-15 ions (e.g., ¹⁵N⁺) or atoms (¹⁵N), among others, or any chemical compounds thereof. Fusionable materials may undergo any of a number of nuclear fusion reactions, as described herein.

The fusionable material may be a single material (e.g., D₂, H₂) or a combination of materials (e.g., D₂ and H₂, D₂ and H₂ and He). The fusionable material may be a combination of at least about 1, 2, 3, 4, 5, 6, 7, 8, 9, 10, or more materials. The fusionable material may be a combination of at most about 10, 9, 8, 7, 6, 5, 4, 3, 2, or 1 materials. The fusionable material may be a combination of a number of materials that is within a range defined by any two of the preceding values. The materials may be combined in any possible proportions. For instance, the fusionable material may be a combination of at least about 1%, 2%, 3%, 4%, 5%, 6%, 7%, 8%, 9%, 10, 11%, 12%, 13%, 14%, 15%, 16%, 17%, 18%, 19%, 20%, 25%, 30%, 35%, 40%, 45%, 50%, 55%, 60%, 65%, 70%, 75%, 80%, 85%, 90%, 95%, 96%, 97%, 98%, 99%, or more of a first fusionable material (e.g., D₂), with the remainder being a second fusionable material (e.g., H₂). The fusionable material may be at most about 99%, 98%, 97%, 96%, 95%, 90%, 85%, 80%, 75%, 70%, 65%, 60%, 55%, 50%, 45%, 40%, 35%, 30%, 25%, 20%, 19%, 18%, 17%, 16%, 15%, 14%, 13%, 12%, 11%, 10%, 9%, 8%, 7%, 6%, 5%, 4%, 3%, 2%, 1%, or less of a first fusionable material (e.g., D₂), with the remainder being a second fusionable material (e.g., H₂). The amount of the first fusionable material and the second fusionable material may be within a range defined by any two of the preceding values. For example, a mixture of fusionable material can be 10%-15% D₂ and 90%-85% H₂. The fusionable material may be provided as a gas phase to the host material. A pressure of the gas may be changed or varied with time.

As used herein, the term “nuclear fusion reaction,” “fusion reaction,” or “fusion” refers to any process that combines two or more atoms of one or more fusionable materials to produce one or more products having a different atomic mass from one or more of the fusionable materials. Nuclear fusion reactions may comprise, but are not limited to, any of the following reactions, along with those exemplified in G. R. Caughlan and W. A. Fowler, “Thermonuclear Reactions Rates V,” Atomic Data and Nuclear Data Tables 40, 283-334 (1988), which is hereby incorporated by reference in its entirety for all purposes:

deuterium+tritium→helium-4+neutron
deuterium+deuterium→tritium+proton
deuterium+deuterium→helium-3+neutron
deuterium+deuterium→helium-4
tritium+tritium→helium-4+2 neutrons
deuterium+helium-3→helium-4+proton
proton+lithium-6→helium-4+helium-3
proton+lithium-7→2 helium-4
proton+boron-11→3 helium-4
proton+proton→deuterium+positron
deuterium+proton→helium-3
helium-3+helium-3→helium-4+2 protons
proton+carbon-12→nitrogen-13
proton+carbon-13→nitrogen-14
proton+nitrogen-14→oxygen-15
proton+nitrogen-15→carbon-12+helium-4
carbon-12+carbon-12→sodium-23+proton
carbon-12+carbon-12→sodium-20+helium-4
carbon-12+carbon-12→magnesium-24

Nuclear fusion reactions may include reactions involving more than two reactants opening decay channels with charged particles carrying away kinetic energy rather than emitting radiation, such as:

H⁺+H⁺+D⁺→³He⁺⁺+H⁺ (Equation 1)

Nuclear fusion reactions may include a series of reactions that include one or more intermediate reactions (e.g., reactions that do not produce the observed products) and transition states, such as:

H⁺+D⁺+D⁺→³He²⁺+D⁺→⁴He²⁺+H⁺+23.8 MeV (Equation 2)

A nuclear fusion reaction may produce additional products beyond the nuclides listed above, such as energy in the form of light, heat, or particles such as neutrinos. A nuclear fusion reaction may release an energy content of a few megaelectron-volts (MeV) or a few 10s of MeV, where 1 MeV=1.6×10⁻¹³ Joules (J). Nuclear fusion reactions that produce heat may be particularly suitable for power generation using the systems and methods described herein.

One or more nuclear fusion reactions described herein may be referred to as “low-energy nuclear fusion reactions”. Such low-energy nuclear fusion reactions may occur between fusionable materials that move with relative velocities (for instance, as measured in the center-of-momentum frame) that are low in comparison to high-temperature nuclear fusion reactions that may require fusionable material to move with average relative velocities of at least about 10⁶ meters per second (m/s) in order to achieve a nuclear fusion reaction. In comparison, the low-energy nuclear fusion reactions described herein may occur between fusionable materials that move with relative velocities of at most about 10⁶ m/s, 9×10⁵ m/s, 8×10⁵ m/s, 7×10⁵ m/s, 6×10⁵ m/s, 5×10⁵ m/s, 4×10⁵ m/s, 3×10⁵ m/s, 2×10⁵ m/s, 10⁵ m/s, 9×10⁴ m/s, 8×10⁴ m/s, 7×10⁴ m/s, 6×10⁴ m/s, 5×10⁴ m/s, 4×10⁴ m/s, 3×10⁴ m/s, 2×10⁴ m/s, 10⁴ m/s, 9×10³ m/s, 8×10³ m/s, 7×10³ m/s, 6×10³ m/s, 5×10³ m/s, 4×10³ m/s, 3×10³ m/s, 2×10³ m/s, 10³ m/s, or less. The low-energy nuclear fusion reactions described herein may occur between fusionable materials that move with relative velocities that are within a range defined by any two of the preceding values.

Although described herein as being particularly applicable to nuclear fusion reactions involving the fusion of two deuterium nuclei or the fusion of one deuterium nucleus and one hydrogen nucleus, the systems and methods described herein may be applicable to any nuclear fusion reaction described herein (e.g., the fusion of a ³He nucleus and a deuterium nucleus, the fusion of a ⁷Li nucleus and a deuterium nucleus).

As used herein, the terms “host material,” “fusion catalyst”, and “fusion catalyst core” refer to any material configured to host at least one fusionable material. The host material may host the fusionable material by containing or trapping the fusionable material within the host material (for instance, within a cavity or vacant space in the host material). The fusionable material may be contained or trapped in the host material. The fusionable material may be dissolved in the host material. The fusionable material may be adsorbed to the host material. The fusionable material may be chemically bonded to the host material.

The host material may be sized or configured to host any amount of fusionable material. For instance, the host material may be sized or configured to host at least about 1, 2, 3, 4, 5, 6, 7, 8, 9, 10, 20, 30, 40, 50, 60, 70, 80, 90, 100, 200, 300, 400, 500, 600, 700, 800, 900, 1,000, or more atoms or ions of fusionable material. The host material may be sized or configured to host at most about 1,000, 900, 800, 700, 600, 500, 400, 300, 200, 100, 90, 80, 70, 60, 50, 40, 30, 20, 10, 9, 8, 7, 6, 5, 4, 3, 2, or 1 atoms or ions of fusionable material. The host material may be sized or configured to host a number of atoms or ions of fusionable material that is within a range defined by any two of the preceding values.

The host material may comprise one or more metals, metal alloys, metal hydrides, metal carbides, metal nitrides, or metal oxides. For instance, the host material may comprise one or more of lithium, beryllium, magnesium, aluminum, calcium, scandium, titanium, vanadium, manganese, iron, cobalt, nickel, copper, zinc, gallium, strontium, yttrium, zirconium, niobium, molybdenum, ruthenium, rhodium, palladium, silver, cadmium, indium, tin, barium, hafnium, tantalum, tungsten, rhenium, osmium, iridium, platinum, gold, mercury, thallium, lead, or bismuth metals, or any alloys, hydrides, carbides, nitrides, or oxides thereof. The host material may comprise at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, or 40 of the preceding metals, or alloys, hydrides, carbides, nitrides, or oxides thereof. The host material may comprise at most about 40, 39, 38, 37, 36, 35, 34, 33, 32, 31, 30, 29, 28, 27, 26, 25, 24, 23, 22, 21, 20, 19, 18, 17, 16, 15, 14, 13, 12, 11, 10, 9, 8, 7, 6, 5, 4, 3, 2, or 1 of the preceding metals, or alloys, hydrides, carbides, nitrides, or oxides thereof. The host material may comprise a number of the preceding metals, or alloys, hydrides, carbides, nitrides, or oxides thereof that is within a range defined by any two of the preceding values.

The host material may comprise particles. The host material may comprise nanoparticles. The nanoparticles may comprise a characteristic dimension (such as a length, width, or radius) of at least about 1 nanometer (nm), 2 nm, 3 nm, 4 nm, 5 nm, 6 nm, 7 nm, 8 nm, 9 nm, 10 nm, 20 nm, 30 nm, 40 nm, 50 nm, 60 nm, 70 nm, 80 nm, 90 nm, 100 nm, 200 nm, 300 nm, 400 nm, 500 nm, 600 nm, 700 nm, 800 nm, 900 nm, 1,000 nm, or more. The nanoparticles may comprise a characteristic dimension of at most about 1,000 nm, 900 nm, 800 nm, 700 nm, 600 nm, 500 nm, 400 nm, 300 nm, 200 nm, 100 nm, 90 nm, 80 nm, 70 nm, 60 nm, 50 nm, 40 nm, 30 nm, 20 nm, 10 nm, 9 nm, 8 nm, 7 nm, 6 nm, 5 nm, 4 nm, 3 nm, 2 nm, 1 nm, or less. The nanoparticles may comprise a characteristic dimension that is within a range defined by any two of the preceding values.

As used herein, the terms “catalyst,” “catalytic,” and “catalytically” refer to devices, materials, methods, and processes that speed up a chemical, nuclear, or physical process. For instance, catalysts may speed up one or more of the nuclear fusion reactions described herein by lowering an activation energy (such as a Coulombic repulsion between two atomic nuclei) of the nuclear fusion reactions, as discussed theoretically by J. Schwinger in “Nuclear energy in an atomic lattice,” Z. Phys. D—Atoms, Molecules and Clusters 15, 221-225 (1990), which is hereby incorporated by reference in its entirety. The catalyst may allow for selection of desirable reaction products, such as helium-4, through the formation of intermediate reaction steps such as in Equation (2).

In an aspect, the present disclosure provides a method for nuclear fusion. The method may comprise: providing a chamber comprising a host material having a fusionable material coupled thereto; providing electromagnetic radiation to the host material or the fusionable material in the chamber to generate oscillations within the host material or the fusionable material, which oscillations are sufficient to subject the fusionable material to a nuclear fusion reaction to yield energy in the chamber; and extracting at least a portion of the energy from the chamber. Temperature and/or pressure oscillations of the fusionable material may be provided in the chamber to generate increased chemical activity at the host material surface. The oscillations may be oscillations of the host material, the fusionable material, or a combination thereof.

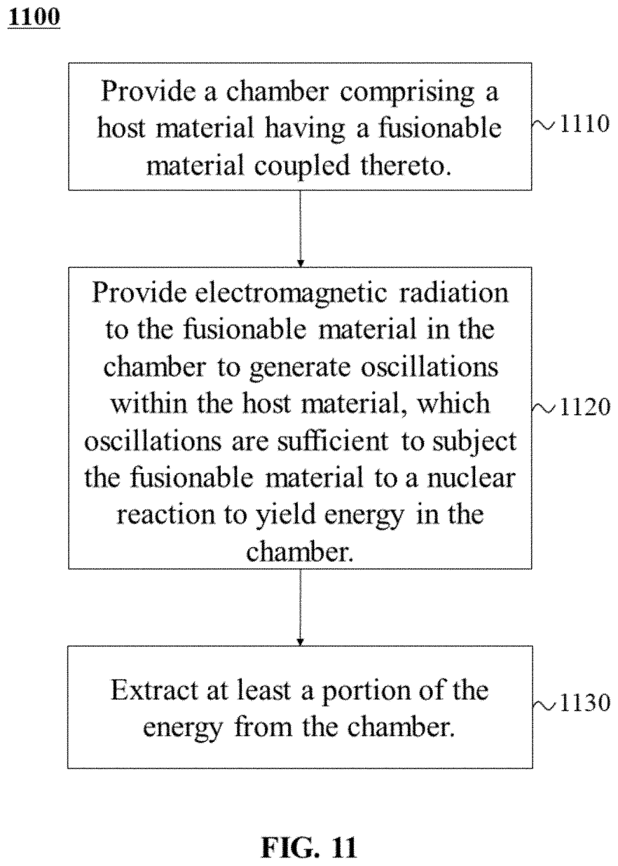

FIG. 11 shows a flowchart for an example of a method 1100 for nuclear fusion.

In a first operation 1110, the method may comprise providing a chamber comprising a host material having a fusionable material coupled thereto. The host material may comprise any host material described herein. For instance, the host material may comprise one or more members selected from the group consisting of: a metal, a metal hydride, a metal carbide, a metal nitride, and a metal oxide. The host material may comprise particles. The host material may comprise nanoparticles, such as any nanoparticles described herein. For instance, the host material may comprise one or more particles comprising a characteristic dimension of at most about 1,000 nanometers (nm).

The fusionable material may comprise any fusionable material described herein. For instance, the fusionable material may comprise one or more members selected from the group consisting of hydrogen, deuterium, lithium, and boron. The pressure and/or temperature of the fusionable material in gaseous form may be controlled within the chamber. The pressure and/or temperature within the chamber may be changed due to one or more inputs from the controller. The pressure and/or temperature may be independently increased or decreased in a periodic manner. The pressure and/or temperature may be controlled at least in part by inducing sonic pressure or shock waves around the fusion catalyst. The inducing the sonic pressure or sonic shock waves may vary the gas phase pressure and/or temperature. For example, the sonic shock waves can increase the kinetic energy, and thus the temperature, of a fusionable gas. In this example, the sonic shock waves can also cause periodic fluctuations in the pressure of the fusionable gas, thus affecting the adsorption kinetics of the gas with the host material.

In a second operation 1120, the method 1100 may comprise providing electromagnetic radiation to the host material and/or the fusionable material in the chamber to generate oscillations within the host material and/or the fusionable material, which oscillations are sufficient to subject the fusionable material to a nuclear fusion reaction to yield energy in the chamber. The oscillations may comprise lattice oscillations of the host material and/or the fusionable material. The oscillations may comprise coherent oscillations. The lattice oscillations may persist for at least about 1, 2, 3, 4, 5, 6, 7, 8, 9, 10, 20, 30, 40, 50, 60, 70, 80, 90, 100, 200, 300, 400, 500, 600, 700, 800, 900, 1,000, or more oscillation periods. The lattice oscillations may persist for at most about 1,000, 900, 800, 700, 600, 500, 400, 300, 200, 100, 90, 80, 70, 60, 50, 40, 30, 20, 10, 9, 8, 7, 6, 5, 4, 3, 2, 1, or fewer oscillation periods. The lattice oscillations may persist for a number of oscillation periods that is within a range defined by any two of the preceding values. The coherent oscillations may comprise phonon oscillations. The phonon oscillations may comprise harmonic phonon oscillations. The harmonic phonon oscillations may comprise parametric phonon oscillations. The oscillations may comprise non-linear phonon oscillations. The oscillations may comprise spatially localized oscillations.

The electromagnetic radiation may comprise any electromagnetic radiation described herein. The electromagnetic radiation may comprise one or more frequencies described herein. For instance, the electromagnetic radiation may comprise one or more frequencies between 1 terahertz (THz) and 50 THz. The electromagnetic radiation may comprise one or more frequencies corresponding to a fundamental, harmonic, or sub-harmonic lattice frequency or surface vibration frequency of the host material and/or the fusionable material.

In a third operation 1130, the method 1100 may comprise extracting at least a portion of the energy from the chamber. The energy may comprise heat. The energy may be extracted using any of the systems and methods described herein. The energy may be extracted using heat transfer mechanisms such as those described in R. W. Serth and T. G. Lestina “Process Heat Transfer: Principles, Applications and Rules of Thumb,” Elsevier Inc. 2^{nd} edition 2014, which is hereby incorporated by reference in its entirety.

The method 1100 may further comprise containing the host material within a heat transfer material configured to extract the heat. The heat transfer material may comprise any heat transfer material described herein. The heat transfer material may comprise any thermal conductivity described herein. For instance, the heat transfer material may comprise a thermal conductivity of at least about 1 Watt meters⁻¹ Kelvin⁻¹ (W m⁻¹ K⁻¹). The heat transfer material may comprise one or more members selected from the group consisting of: carbon nanotubes (CNTs), single-walled CNTs, double-walled CNTs, multi-walled CNTs (e.g., triple-walled CNTs, quadruple-walled CNTs, etc.), graphite, graphene, diamond, zirconium oxide, aluminum oxide, and aluminum nitride.

The method 1100 may further comprise containing the heat transfer material within a heat exchange fluid. The heat exchange fluid may comprise any heat exchange fluid described herein.

The method 1100 may further comprise using the heat exchange fluid to drive a generator or any other energy-conversion system described herein.

In another aspect, the present disclosure provides a method for low-energy nuclear fusion.

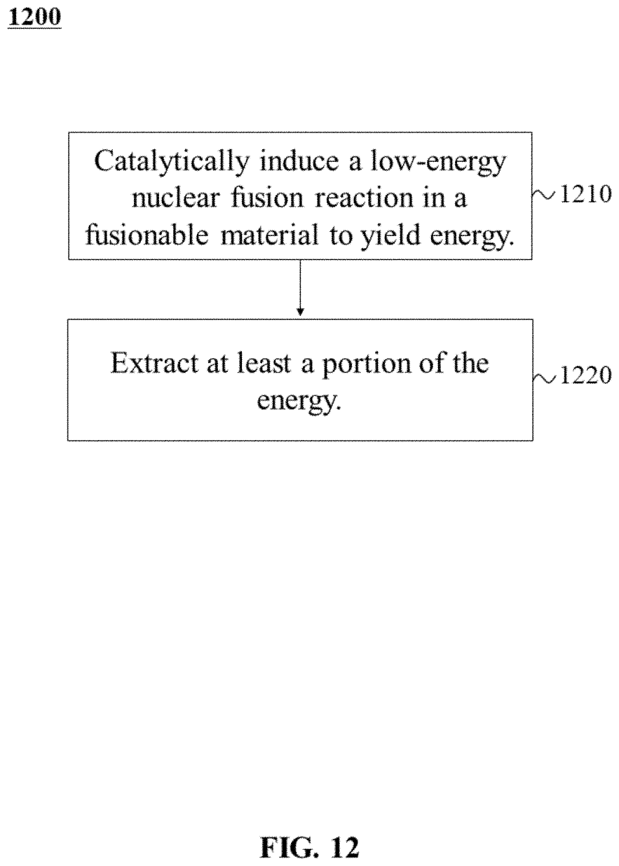

FIG. 12 shows a flowchart for an example of a method 1200 for low-energy nuclear fusion.

In a first operation 1210, the method 1200 may comprise catalytically inducing a low-energy nuclear fusion reaction in a fusionable material to yield energy. The fusionable material may comprise any fusionable material described herein.

In a second operation 1220, the method 1200 may comprise extracting at least a portion of the energy. The energy may comprise heat. The energy may be extracted using any of the systems and methods described herein.

The reaction shown in Equation 3 represents a possible pathway for deuterium-deuterium fusion where D⁺ refers to a positively-charged deuterium nucleus (also referred to as a D+ion). Such a reaction may be more likely to occur at extreme high temperatures and extreme high pressures, such as in the cores of stars:

D⁺+D⁺→⁴He²⁺+23.8 MeV (Equation 3)

At lower pressures and temperatures, the probability for the reaction of Equation 1 to occur may ordinarily be vanishingly small. The high potential energy barrier may prevent two positively-charged deuterium nuclei from getting close enough for nuclear attractive forces to bond the two D+ions and form a helium-4 (4He) nucleus, which may allow such a reaction to take place only at extremely high pressures and temperatures. However, if the D atoms or ions are confined to a host material (such as in a palladium hydride metal lattice), molecular vibrations of the host material may result in oscillations of the D atoms or ions in a local potential energy minimum, even at temperatures or pressures significantly lower than those at which the reaction of Equation 3 or any other nuclear fusion reaction described herein may readily occur. At relatively low temperatures, external stimulation may be provided to the host material to excite some, many, or all vibrational modes of the host material or the fusionable material to drive a nuclear fusion reaction (such as the nuclear fusion reaction described by Equation 3 or any other nuclear fusion reaction described herein). Higher energy excitations near the natural oscillation frequency may be thermally activated with an exponential factor that depends on the ratio of the energy to the temperature, as described in Equation 4.

$$n ( E ) = \frac{1}{{e}^{E / k T} - 1} \qquad ( Equation 4 )$$

Here, n(E) is the occupation of the mode having energy E, E is the vibration energy, k is the Boltzmann constant, T is the temperature, and e is the base of the natural logarithm. By coherently driving the host material at a sub-harmonic or harmonic of the natural vibrational frequency of the local potential energy well, the relevant oscillations may be “pumped” directly so that the fluctuations in the positions of the D nuclei become sufficiently large (owing to the position-momentum uncertainty principle), resulting in a reduced Coulomb barrier. Such Coulomb barrier reduction may enable the D-D nuclei to fuse at an elevated rate even at relatively lower temperature conditions. The systems and methods described herein may utilize a fusion catalyst core that places deuterium in a host material (such as a metal lattice) and applies electromagnetic radiation to this fusion catalyst core to pump the vibrations in order to achieve the nuclear fusion reaction described in Equation 1 at significantly reduced pressures and temperatures. Although described herein with respect to the nuclear fusion reaction of Equation 1, nuclear fusion reactions may be achieved using the systems and methods of the present disclosure, such as ⁷Li+H⁺→⁸Be →2 ⁴He+17.2 MeV, as well as nuclear fusion reactions involving different hydrogen isotopes including hydrogen, deuterium, and tritium or any other nuclear fusion reaction described herein. The fusion of ⁷Li+H⁺→⁸Be may be an example of an intermediate reaction step, as the ⁸Be then decomposes to form the observed 2 ⁴He nuclei.

Low-energy nuclear reactions (LENR) may involve the reaction of two or more atoms or ions of a hydrogen isotope (such as hydrogen, deuterium, or tritium) to form a helium isotope (such as helium-3 or helium-4) accompanied by the release of energy in the form of high energy particles, excited nuclear states, or heat. In one particular nuclear reaction, two deuterium atoms or ions contained in a host material (for instance, dissolved in a palladium metal lattice) may combine to form one helium atom or ion accompanied by the release of 23.8 MeV of energy, as indicated in Equation 2. Such nuclear fusion reactions may be considered to be essentially instantaneous (i.e., occurring on a time scale much shorter than 1 femtosecond). While 23.8 MeV may be a small amount of energy (equivalent to 3.81×10⁻¹² Joules), if it is released instantaneously and the heat injected in a small amount of material, this amount of energy released in the form of heat may raise the temperature locally within the host material by a large amount and may result in local disruption or even vaporization of solid state structures. For instance, if a single nuclear fusion reaction releases 23.8 MeV of heat into a 100 nm diameter region of palladium metal or a 100 nm diameter nanoparticle of palladium, the palladium metal region or the nanoparticle may experience a rise in temperature to approximately 2,600° C. If this heat is released into a 10 nm diameter region of palladium metal or a 10 nm diameter palladium nanoparticle, the temperature of this region or particle may rise to approximately 2.6×10⁶° C., which may be sufficient to vaporize the nanoparticle and thereby preclude an enhanced fusion rate for subsequent fusion reactions.

To improve stability of the host material, the host material may not be located alone in a vacuum but may be combined with a heat transfer material that can transmit this heat away to a surrounding mass and thus remove a portion of the heat from the host material, which may result in a lower temperature rise.

### Catalytic Site for Fusion Reaction

The site for fusion may comprise small particles of a host material loaded with a fusionable material (such as deuterium to form a hydride or deuteride, such as palladium deuteride).

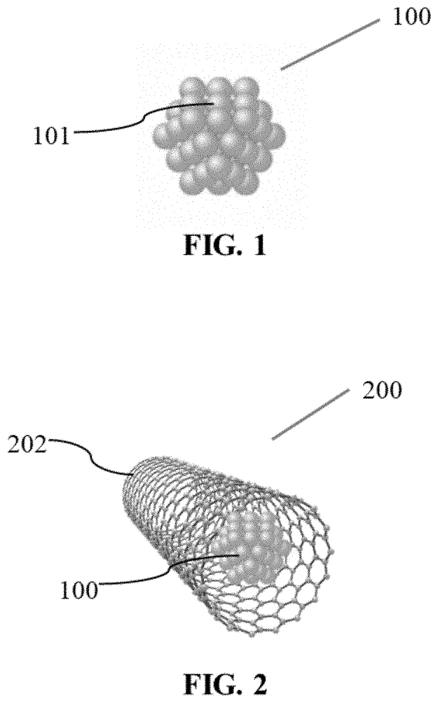

FIG. 1 shows an example of a fusion catalyst core comprising a nanoparticle 100 of palladium with a face centered cubic structure. For palladium, which forms a face centered cubic lattice structure (fcc), the palladium atoms at the center of the particle may have 12 nearest neighbors or a coordination number of 12 or each Pd atom may have 12 nearest neighbors and be bonded to these 12 Pd atoms. At the surface, the coordination number may be smaller. For example, as shown in FIG. 1, atom 101 may have a coordination number of 8, and may thus be bonded to 8 other Pd atoms. Although described in FIG. 1 as comprising palladium, the atoms may comprise any host material described herein. Other surface atoms may have similarly low coordination number. The atoms with lower coordination number may be held less tightly and thus may be able to vibrate more easily. As described herein, Pd loaded with a fusionable material (such as deuterium) may be stimulated with a radiation source to excite vibrations of the host material atoms and the fusionable material atoms or ions. In some embodiments, the host material may comprise nanoparticles. The nanoparticles may comprise core-shell nanoparticles, core-multishell nanoparticles (e.g., core-shell-shell nanoparticles), alloy nanoparticles, or intermetallic nanoparticles. The nanoparticles may comprise many atoms with low coordination number and may be affected to a larger or smaller extent and aid in driving the reaction described in Equation 1 or any other nuclear fusion reaction described herein. Because the local energy release may be very large, such nanoparticles may be contained in a heat transfer material, as described herein. Amorphous or bimetallic alloy nanoparticles may be host to a number of crystalline defects that may further serve as attractive centers for atoms or ions of fusionable material to cluster and oscillate with large amplitude.

In some embodiments, host material nanoparticles 100 (referred to herein alternatively as a fusion catalyst core) may be fabricated and subsequently coated with, placed within, or surrounded by a heat transfer material. The heat transfer material may comprise a high thermal conductivity. The heat transfer material may comprise a thermal conductivity of at least about 1 Watt meter⁻¹ Kelvin⁻¹ (W m⁻¹ K⁻¹), 2 W m⁻¹ K⁻¹, 3 W m⁻¹ K⁻¹, 4 W m⁻¹ K⁻¹, 5 W m⁻¹ K⁻¹, 6 W m⁻¹ K⁻¹, 7 W m⁻¹ K⁻¹, 8 W m⁻¹ K⁻¹, 9 W m⁻¹ K⁻¹, 10 W m⁻¹ K⁻¹, 20 W m⁻¹ K⁻¹, 30 W m⁻¹ K⁻¹, 40 W m⁻¹ K⁻¹, 50 W m⁻¹ K⁻¹, 60 W m⁻¹ K⁻¹, 70 W m⁻¹ K⁻¹, 80 W m⁻¹ K⁻¹, 90 W m⁻¹ K⁻¹, 100 W m⁻¹ K⁻¹, 200 W m⁻¹ K⁻¹, 300 W m⁻¹ K⁻¹, 400 W m⁻¹ K⁻¹, 500 W m⁻¹ K⁻¹, 600 W m⁻¹ K⁻¹, 700 W m⁻¹ K⁻¹, 800 W m⁻¹ K⁻¹, 900 W m⁻¹ K⁻¹, 1,000 W m⁻¹ K⁻¹, 2,000 W m⁻¹ K⁻¹, 3,000 W m⁻¹ K⁻¹, 4,000 W m⁻¹ K⁻¹, 5,000 W m⁻¹ K⁻¹, 6,000 W m⁻¹ K⁻¹, 7,000 W m⁻¹ K⁻¹, 8,000 W m⁻¹ K⁻¹, 9,000 W m⁻¹ K⁻¹, 10,000 W m⁻¹ K⁻¹, or more. The heat transfer material may comprise a thermal conductivity of at most about 10,000 W m⁻¹ K⁻¹, 9,000 W m⁻¹ K⁻¹, 8,000 W m⁻¹ K⁻¹, 7,000 W m⁻¹ K⁻¹, 6,000 W m⁻¹ K⁻¹, 5,000 W m⁻¹ K⁻¹, 4,000 W m⁻¹ K⁻¹, 3,000 W m⁻¹ K⁻¹, 2,000 W m⁻¹ K⁻¹, 1,000 W m⁻¹ K⁻¹, 900 W m⁻¹ K⁻¹, 800 W m⁻¹ K⁻¹, 700 W m⁻¹ K⁻¹, 600 W m⁻¹ K⁻¹, 500 W m⁻¹ K⁻¹, 400 W m⁻¹ K⁻¹, 300 W m 1K⁻¹, 200 W m⁻¹ K⁻¹, 100 W m⁻¹ K⁻¹, 90 W m⁻¹ K⁻¹, 80 W m⁻¹ K⁻¹, 70 W m⁻¹ K⁻¹, 60 W m⁻¹ K⁻¹, 50 W m⁻¹ K⁻¹, 40 W m⁻¹ K⁻¹, 30 W m⁻¹ K⁻¹, 20 W m⁻¹ K⁻¹, 10 W m⁻¹ K⁻¹, 9 W m⁻¹ K⁻¹, 8 W m⁻¹ K⁻¹, 7 W m⁻¹ K⁻¹, 6 W m⁻¹ K⁻¹, 5 W m⁻¹ K⁻¹, 4 W m⁻¹ K⁻¹, 3 W m⁻¹ K⁻¹, 2 W m⁻¹ K⁻¹, 1 W m⁻¹ K⁻¹, or less. The heat transfer material may comprise a thermal conductivity that is within a range defined by any two of the preceding values. The thermal conductivities of some materials are shown in the Table 1.

TABLE 1
Thermal conductivities of selected materials.

| | Thermal conductivity |
|---|---|
| Material | Watts/meter-K |
| Palladium metal | 71.2 |
| Zirconium oxide | 3 |
| Aluminum oxide | 25 |
| Aluminum nitride | 150 |
| Diamond | 2,000 |
| Carbon Nanotube | 3,000 to 6,600 (estimated) |

Imbedding particles of the host material in a heat transfer material such as a carbide, nitride, or oxide such as zirconium oxide, aluminum oxide, or aluminum nitride may provide some pathway for heat removal. Other heat transfer materials such as diamond, graphene, or carbon nanotubes (CNTs) may provide a significantly higher pathway to distribute the heat and reduce the local hot spot temperature. In particular, conducting the fusion reaction in a host material nanoparticle inside of a CNT may conduct the heat rapidly along the length of the CNT and dissipate this heat to the surrounding media (such as an oxide or heat transfer fluid) in which the CNT is imbedded.

In some embodiments, small particles of host material (such as that shown in FIG. 1) may be at least partially deposited within a CNT. In some embodiments, the host material may be at least partially deposited within a graded thermal conductivity construction. The graded thermal conductivity construction may be may have a high thermal conductivity around the host material which itself is surrounded with a different material with a lower thermal conductivity. For example, a nanoparticle host can be deposited within a CNT, which itself is deposited within a porous medium thermal conductivity material. The heat transfer material may comprise a material having a higher thermal conductivity region nearer to the host material and a lower thermal conductivity region further from the host material. The heat transfer material may comprise at least about 1, 2, 3, 4, 5, 6, 7, 8, 9, 10, or more materials in mutual thermal contact. The heat transfer material may comprise at most about 10, 9, 8, 7, 6, 5, 4, 3, 2, 1, or fewer materials in mutual thermal contact. The heat transfer material may comprise a number of materials in mutual thermal contact that is within a range defined by any two of the preceding values. The higher thermal conductivity region may comprise a porous medium thermal conductivity material (e.g., a porous oxide material).

FIG. 2 shows an example of a system 200 comprising a fusion catalyst core deposited inside a single wall carbon nanotube. The host material nanoparticle 100 may be deposited inside a single wall CNT 202. The CNT may have one or both ends open to allow reactants to access the host material nanoparticle. Alternatively, the CNT may have both ends closed. One or more host material nanoparticles 100 may be located within the CNT and located along its length or distributed against a wall of the carbon nanotube. In some embodiments, host material nanoparticles may be deposited on the outside of the CNT. Host material nanoparticles deposited on the outside of the CNTs may also act as a fusion catalyst core, and such nanoparticles may benefit from the high thermal conductivity of the CNT. The CNTs may be single wall carbon nanotubes, or multiwall carbon nanotubes (MWCNTs).

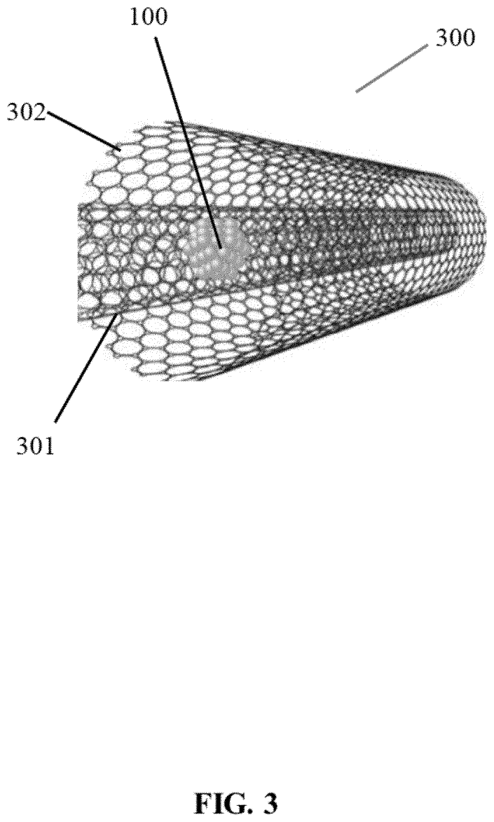

FIG. 3 shows an example of a system 300 comprising a fusion catalyst core deposited inside a multiwall carbon nanotube. The fusion catalyst core 100 may be located within a MWCNT structure with inner carbon nanotube 301 surrounded by outer carbon nanotube 302. Inner carbon nanotube 301 and outer carbon nanotube 302 may be similar to any carbon nanotube described herein. Again, the MWCNT may have one or both ends open to allow access by reactants. Alternatively, the MWCNT may have both ends closed. The carbon nanotubes with host material nanoparticles contained within (as shown in FIGS. 2 and 3) may be used alone as a fusion catalyst suspended in a flowing heat transfer material, as described herein.

As described herein, the fusion catalyst may be contained within a packed bed reactor through which heat transfer material flows so that heat generated in the fusion catalyst may be carried out of the reactor bed to a location where the heat may be used for some purpose (such as to drive a generator or turbine). Alternatively or in combination, the fusion catalyst may comprise particulates suspended in the heat transfer material and may flow through the reactor zone to the heat exchange zone where heat may be extracted from the flowing media and the suspended catalyst may return to the reactor where further nuclear fusion reactions may take place.

The carbon nanotubes can range in size with an internal diameter of at least about 1 nm, 2 nm, 3 nm, 4 nm, 5 nm, 6 nm, 7 nm, 8 nm, 9 nm, 10 nm, 20 nm, 30 nm, 40 nm, 50 nm, 60 nm, 70 nm, 80 nm, 90 nm, 100 nm, or more. The carbon nanotubes may comprise an internal diameter of at most about 100 nm, 90 nm, 80 nm, 70 nm, 60 nm, 50 nm, 40 nm, 30 nm, 20 nm, 10 nm, 9 nm, 8 nm, 7 nm, 6 nm, 5 nm, 4 nm, 3 nm, 2 nm, 1 nm, or less. The carbon nanotubes may comprise an internal diameter that is within a range defined by any two of the preceding values. The carbon nanotubes can be of a single wall design or a multiwall design wherein one or more nanotubes are located inside a larger nanotube like a pipe within a pipe. The host material nanoparticles may be located inside the single wall nanotube, or inside the innermost carbon nanotube of a multiwall nanotube, or located between the walls of the one or more nanotubes that make up a multiwall nanotube. The ends of the carbon nanotubes may be open; that is, that the tubes may have either one or both ends open similar to an open pipe.

The operation of the fusion catalyst core may be preserved using a surrounding nanostructure (such as a multiwall carbon nanotube). A host material nanoparticle embedded inside a carbon nanotube with insufficient heat transport, such as a particularly short CNT, may be subjected to local heat release (from the nuclear fusion reaction of the fusionable material) that may heat or melt the host material nanoparticle. This may allow nuclear fusion products (such as helium-3 or helium-4) trapped in the host material nanoparticle to escape, thereby avoiding the buildup of nuclear fusion products while further preventing the aggregation of host material nanoparticles. This may allow for the reconstitution of the nanoparticle within the CNT after a melting event and allow the fusion catalyst core to continue to operate. Alternatively or in combination, a single CNT, or multiple concentric MWCNTs, each with short or long CNT lengths, may be used to vary the fusion catalyst core temperature during the nuclear fusion reaction, thereby allowing for an improved or optimized temperature rise or an improved or optimized maximum temperature. The nanoparticles inside CNTs may be synthesized as described in J. P. Tessonnier et al. “Pd nanoparticles introduced inside multi-walled carbon nanotubes for selective hydrogenation of cinnamaldehye into hydrocinnamaldehyde,” Applied Catalysis A: General 288, 203-210 (2005), which is hereby incorporated by reference in its entirety.

Catalytic Site Contained within Ceramic

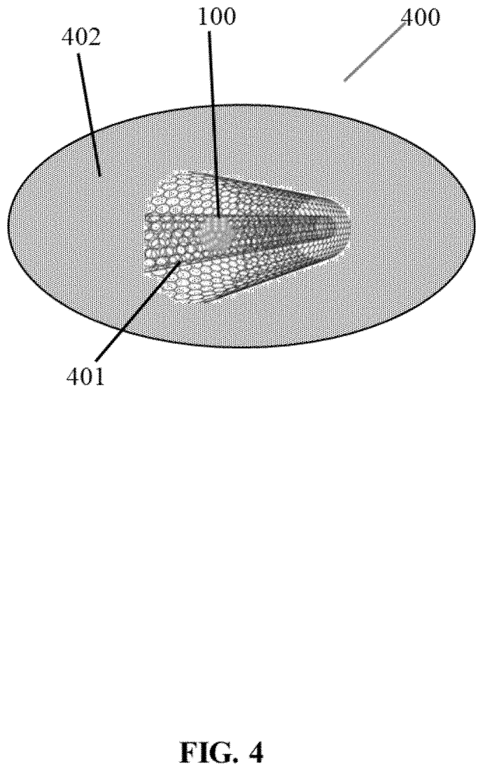

FIG. 4 shows an example of a system 400 comprising a fusion catalyst core deposited inside a multiwall carbon nanotube inside a coating of porous ceramic. The host material nanoparticle 100 may be deposited inside carbon nanotube 401 (which may be similar to any carbon nanotube described herein, such as any carbon nanotube described herein with respect to FIG. 2 or 3) and this structure may be imbedded within a ceramic material (such as a porous ceramic material) 402. One or more CNT or MWCNT units containing one or more fusion catalyst cores may be located within such ceramic materials as bundles or as rod-like structures. The ceramic structure may have good thermal heat transfer contact with the carbon nanotube material and the ceramic structure may have a high thermal heat capacity and thermal conductivity. For instance, the ceramic may have any thermal conductivity described herein. The porous ceramic structure may have a pore structure with pores sized to allow fusionable materials (such as deuterium) to access the CNTs and the host material nanoparticles. The heat released into the fusion catalyst core may effectively transfer heat generated by nuclear fusion of the fusionable material to the CNT or MWCNT, which may effectively transfer the heat along the length of the CNT or MWCNT and pass it to the ceramic material surrounding the CNT or MWCNT. Single wall CNTs with high thermal conductivities may be highly effective in transferring heat along their lengths and transmitting the heat to the surrounding medium. Multiwall CNTs may be even better since the nested MWCNTs may be more effective in transferring the heat generated in the host material particle.

### Flat Plate Type Fusion Catalyst Structures

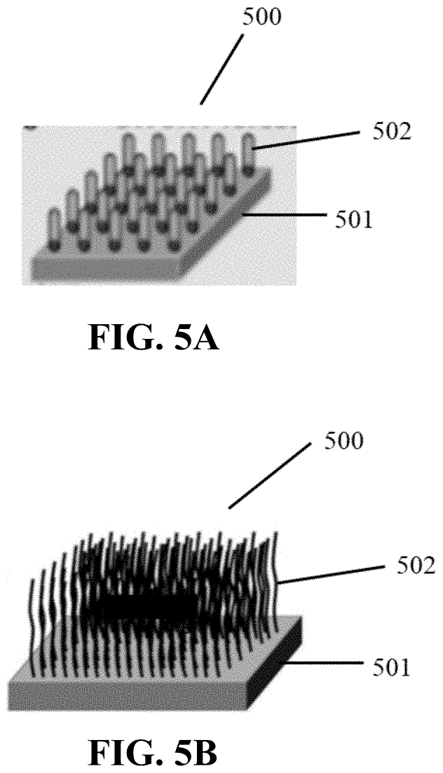

FIG. 5A shows an example of a growth process of carbon nanotubes on a flat substrate. A flat plate catalyst structure 500 may be formed from plate 501. The catalyst structure may comprise a material upon which the CNTs or MWCNTs 502 (which may be similar to any carbon nanotube described herein, such as any carbon nanotube described herein with respect to FIG. 2, 3, or 4) are grown as long linear structures, which may be referred to as a CNT “forest” (as depicted in FIG. 5B) grown on the flat plate 501. The CNTs or MWCNTs forest may have host material nanoparticles deposited within the CNTs 502, as described herein (for instance, with respect to FIG. 2, 3, or 4). During a nuclear fusion reaction, heat generated at the fusion catalyst core may be conducted along the CNT and transferred to the flat plate 501.

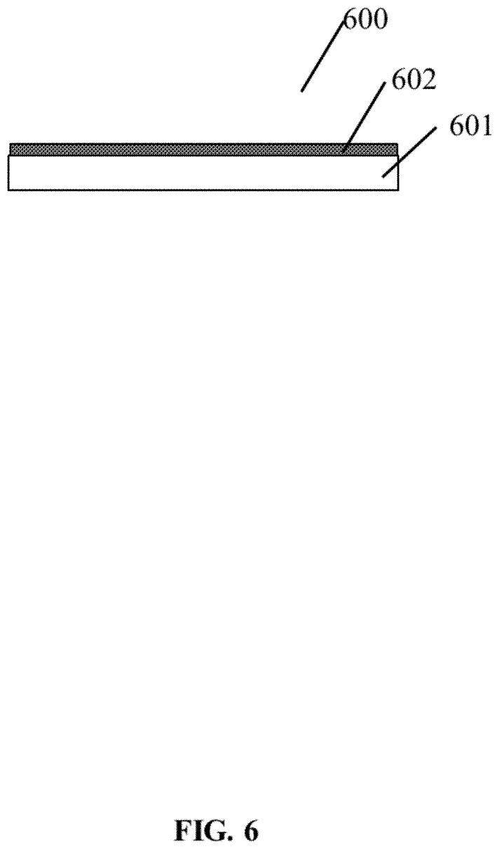

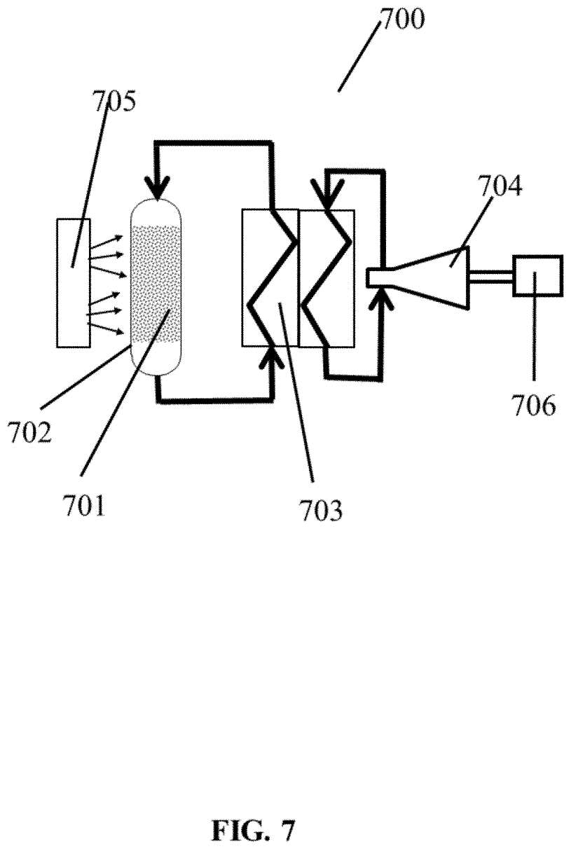

FIG. 6 shows an example of a system 600 comprising a fusion catalyst core comprising a layer on a plate. A high thermal conductivity support block or metal plate 601 may have a thin coating 602 applied to one or both sides. The thin coating 602 may contain the fusion catalyst dispersed in a ceramic that is applied to the plate 601 much like a washcoat or layer of paint. The fusion catalyst can be either host material nanoparticles alone (for instance, as depicted in FIG. 1), host material nanoparticles dispersed in a ceramic or other porous material, or host material nanoparticles located in CNTs or MWCNTs (for instance, as depicted in FIGS. 2 and 3). As described herein, the composition of the coating may be selected to have high thermal conductivity to aid conduction of heat away from the fusion catalyst and into the plate structure.

### Operation of the Fusion Catalyst

In operation, the fusion catalyst core described with respect to FIGS. 1, 2, and 3 may be exposed to a fusionable material. For instance, the fusion catalyst core may be exposed to deuterium gas, D₂, hydrogen gas, H₂, or a combination thereof. The D₂, H₂, or a combination thereof may dissolve into the host material (such as Pd metal) and may reside as D and/or H atoms or ions in the interstitial spaces of the host material (such as in the interstitial spaces in the Pd metal). The fusion catalyst core may be exposed to other fusible materials (e.g., ³He, ⁷Be). The fusible material may be a gas, a liquid, a solvated species, or a solid. The temperature and pressure of the gas may be controlled to increase or decrease the concentration of dissolved fusionable material at the host material surface. For example, increasing the temperature and decreasing the pressure can be used to desorb fusionable material from the host material. The host material containing the fusionable material may then be stimulated with electromagnetic radiation from an electromagnetic radiation source to incoherently, semi-coherently, or coherently drive phonons in the nanoparticle and induce a nuclear fusion reaction, such as the reaction described in Equation 1 or any other nuclear fusion reaction described herein. This electromagnetic radiation source may be selected to stimulate phonons in the fusion catalyst core and may be tuned to emit electromagnetic radiation having a frequency that stimulates the phonons.

The electromagnetic radiation source may comprise a laser, lamp, light-emitting diode (LED) or a terahertz (THZ) light source or a broadband light source with or without a spectrally selective filter. The beam geometry or diameter may be optimized with beam expanders to cover the maximum fusion catalyst surface area.

The electromagnetic radiation source may comprise one or more terahertz (THz) sources. The electromagnetic radiation source may comprise one or more light sources, such as one or more laser sources. The electromagnetic radiation source may comprise one or more quantum cascade laser sources. The electromagnetic radiation source may be configured to emit electromagnetic radiation comprising one or more frequencies of at least about 1 THz, 2 THz, 3 THz, 4 THz, 5 THz, 6 THz, 7 THz, 8 THz, 9 THz, 10 THz, 20 THz, 30 THz, 40 THz, 50 THz, 60 THz, 70 THz, 80 THz, 90 THz, 100 THz, or more. The electromagnetic radiation source may be configured to emit electromagnetic radiation comprising one or more frequencies of at most about 100 THz, 90 THz, 80 THz, 70 THz, 60 THz, 50 THz, 40 THz, 30 THz, 20 THz, 10 THz, 9 THz, 8 THz, 7 THz, 6 THz, 5 THz, 4 THz, 3 THz, 2 THz, 1 THz, or less. The electromagnetic radiation source may be configured to emit electromagnetic radiation comprising one or more frequencies that are within a range defined by any two of the preceding values. For instances, the electromagnetic radiation source may be configured to emit electromagnetic radiation comprising one or more frequencies that are within a range from about 1 THz to about 60 THz, about 1 THz to about 55 THz, about 1 THz to about 50 THz, about 20 THz to about 60 THz, about 20 THz to about 55 THz, about 20 THz to about 50 THz, about 20 THz to about 45 THz, about 25 THz to about 60 THz, about 25 THz to about 55 THz, or about 25 THz to about 50 THz. The electromagnetic radiation source may comprise one or more broadband light sources, such as one or more light-emitting diodes (LEDs). The broadband light sources may be filtered to emit electromagnetic radiation having one or more frequencies described herein.

The electromagnetic radiation source may be configured to emit electromagnetic radiation comprising one or more frequencies corresponding to a harmonic or sub-harmonic of the natural frequency of the local potential energy well felt by the fusionable material. In some cases, the electromagnetic radiation source may be configured to emit electromagnetic radiation comprising one or more frequencies corresponding to twice the vibration frequency of the fusionable material inside of, or on the surface of, the host material. The fusionable material vibration frequencies (such as the deuterium vibration frequencies) of various host materials containing fusible materials can be ascertained though neutron scattering experiments. Other probes sensitive to lattice vibrations, such as Raman spectroscopy, can be used to ascertain such frequencies through the observation of resonances that can be associated with fusionable material vibrations.

### Conversion of Heat Energy

FIG. 7 shows an example of a thermal electric generation system 700 using a fusion catalyst core configured to generate steam to drive a steam turbine. The fusion catalyst 701 may be contained in a packed bed reactor 702. The fusion catalyst may be in the form of pellets or beads, as described herein (for instance, with respect to FIG. 4). These pellets or beads may allow a heat exchange fluid containing fusionable material (such as a heat exchange fluid containing deuterium gas, D₂, H₂, or a combination thereof) to flow through the fusion catalyst bed, extracting heat from the fusion catalyst and heating the heat transfer material. As the partial pressure of the D₂, H₂, or a combination thereof in the heat exchange fluid decreases, it may be replenished to a desired partial pressure range and any nuclear fusion products (such as helium-3 or helium-4) may be purged. The system depicted in FIG. 7 shows the heat utilized by heat exchange in a heat exchange boiler 703 and the steam used to drive a steam turbine 704 and generator 706. Alternative methods of utilizing the heat may be utilized. Alternatively or in combination, the fusion catalyst 701 may comprise an open channel or channel-like structure with the fusion catalyst coated on the surface of the open channel structure. Electromagnetic radiation source 705 may stimulate (for instance, by emitting any electromagnetic radiation described herein) the fusion catalyst core to cause the fusion reaction. In this design, the reactor wall and the material of the fusion catalyst bed may be completely or partially transparent to the electromagnetic radiation so that the radiation can reach the fusion catalyst core to induce the fusion reaction. Though described in reference to H₂, D₂, or a combination thereof, the fusionable material may be any fusible material as described herein.

Alternatively or in combination, the fusion catalyst may be dispersed as small particles suspended in the heat transfer fluid such that the fusion catalyst may move with the heat transfer fluid. This may allow the reactor section 702 to be constructed of a material with a high transmittance for the electromagnetic radiation. In addition, the reactor 702 may be designed such that it has a large surface area facing the electromagnetic radiation source 705, which may allow good exposure of the fusion catalyst core to the electromagnetic radiation. The heat transfer fluid may also be saturated with the fusionable material (such as deuterium gas, D₂, H₂, or a combination thereof) and the partial pressure maintained at a target value. Alternatively or in combination, D₂ gas or D₂ gas mixed with other gaseous components (e.g., mixed with H₂ gas) may function as the heat transfer fluid with fusion catalyst suspended in and flowing with the gas stream. This may have the advantage of high transmittance to the electromagnetic radiation.

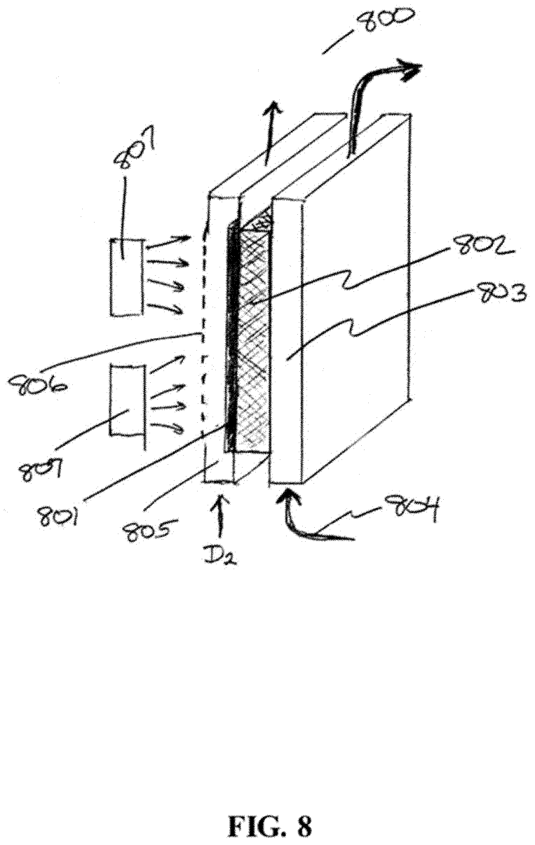

FIG. 8 shows an example of a reactor comprising a fusion catalyst core deposited as a layer on a heat exchanger surface configured to transfer heat to a heat transfer medium. The reactor 800 may comprise the fusion catalyst 801 as a layer affixed to a solid plate-like structure with high thermal conductivity 802. This solid structure 802 may conduct heat from the fusion catalyst layer 801 to a heat exchange section 803 through which heat exchange media 804 may flow. D₂ gas, H₂ gas, or a combination thereof may be provided through channel 805 and may flow by the fusion catalyst layer 801. One side of the channel 805 may be composed of a material with high transmittance 806 for the electromagnetic radiation provided by electromagnetic radiation sources 807 (which may be similar to any electromagnetic radiation sources described herein). The fusion catalyst layer can be comprised of host material nanoparticles dispersed in a ceramic medium, host material nanoparticles inside CNTs or MWCNTs dispersed in a ceramic medium (for instance, as depicted in FIG. 4), host material nanoparticles inside CNTs or MWCNTs grown as a forest (for instance, as depicted in FIG. 5).

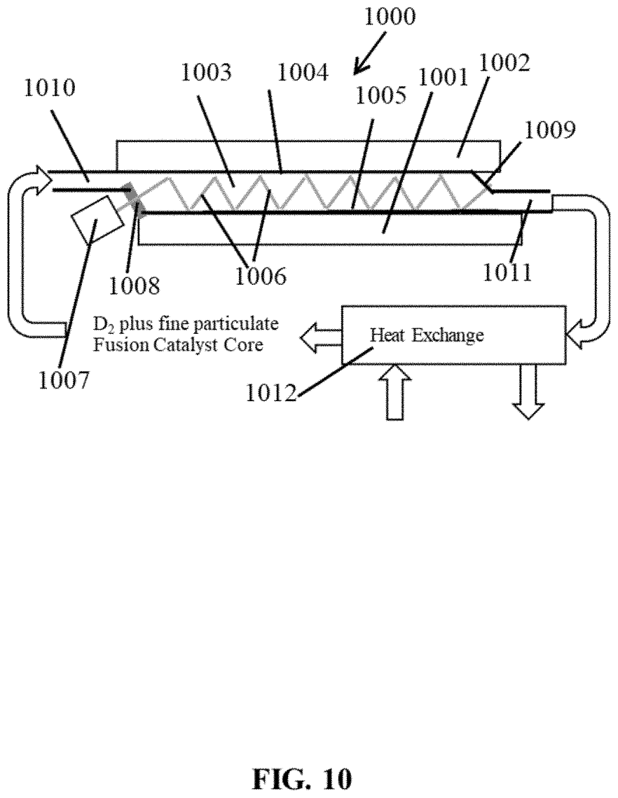

FIG. 10 shows an example of a thermal generation system comprising a flat plate reactor. Reactor 1000 may comprise a flat plate type reactor (shown in cross-section in FIG. 10) with flat plates 1001 and 1002 separated to form a flat tank-like reactor chamber 1003. The internal surfaces 1004 and 1005 of the tank structure may be coated with a reflective mirror material that may have a high reflectance for electromagnetic radiation 1006 produced by electromagnetic radiation source 1007 (which may be similar to any electromagnetic radiation source described herein). One end of the reactor chamber 1003 may be formed of an entrance window 1008 that may have a high transmittance for the electromagnetic radiation 1006. The other end of the reactor chamber 1003 may be formed of a mirrored surface 1009 that may have a similar coating to the coating applied to the internal surfaces 1004 and 1005 and that may reflect the electromagnetic radiation 1006 back into the channel 1003. The rectangular chamber 1003 may form a reactor through which the fusion catalyst material may flow contained in a heat exchange fluid that may flow in through pipe 1010 at the reactor inlet and out the outlet 1011. The heat exchange fluid may be a gas (e.g., D₂, H₂), a mixture of gasses (e.g., a mixture of D₂ and H₂), a gas with the fusion catalyst dispersed as a fine solid in this gas phase (e.g., D₂ gas with Pd nanoparticles dispersed in the gas), or a liquid with the fusion catalyst suspended in the liquid along with the fusible reactants (e.g., diethyl ether with dissolved H₂ and D₂ and Pd nanoparticles suspended therein). This heat exchange fluid may be heated by the fusion reaction that is stimulated in the reactor chamber by the electromagnetic radiation on the fusion catalyst. The hot heat exchange medium may flow through heat exchanger 1012 and then back into the reactor. Heat may be extracted from the heat exchanger for a useful purpose. The fusion catalyst may comprise fine particulates containing the fusion catalyst core inside CNT or MWCNT type materials or any of the other forms described herein. Alternatively or in combination, the fusion catalyst core may be contained in CNT or MWCNTs grown as long fibers on the surface of the mirrored surfaces 1004 and 1005. The transparent windows may comprise organic polymers such as polyethylene.

Although described as comprising a flat plate type reactor in FIG. 10, the reactor 1000 may comprise any possible geometry. The geometry may be chosen in order to increase or optimize the exposure of the host material and/or fusionable material to electromagnetic radiation and/or to reduce or minimize losses. For instance, the reactor 1000 may comprise a cylindrical, spherical, polyhedral, cubic, rectangular prism, pyramidal, or other form.

Heat provided by the nuclear fusion reactions described herein may be extracted for a useful purpose using a variety of thermodynamic processes. For instance, the heat may be extracted using a variety of thermodynamic cycles, such as a Stirling cycle, Brayton cycle, or Rankine cycle. The heat may be used to generate linear or rotational energy using a piston, turbine, steam engine, or any other energy-conversion device. The heat may be used for refrigeration by applying an absorptive refrigeration cycle.

### Primary Battery Designs

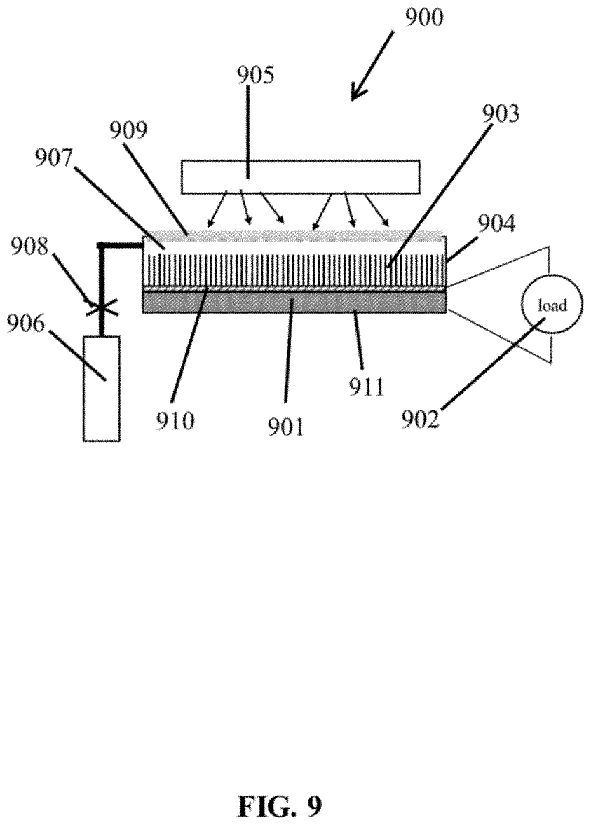

FIG. 9 shows an example of a primary battery design using deuterium fuel and a thermoelectric plate. In this configuration 900, a thermoelectric generator 901 may configured to produce electric power to a load 902. One side of the thermoelectric generator may be coated with the Fusion Catalyst 903. The fusion catalyst may be within a coating on the surface of the structure 901. The fusion catalyst may be a forest of carbon nanotubes grown on the surface of the structure 901. Such a forest connected to the thermoelectric generator 901 may provide heat transfer from the fusion catalyst to the thermoelectric generator 901. The fusion catalyst 903 may be contained within an enclosure in 904. Structure 907 may be substantially gas tight and may have at least one side 909 comprising one or more window structures having good transmittance to the phonon-stimulating electromagnetic radiation produced by electromagnetic radiation source 905 (which may be similar to any electromagnetic radiation source described herein). A source 906 of D₂ gas, H₂ gas, or a combination thereof may be provided to maintain D₂, H₂, or a combination thereof at a substantially constant partial pressure over the fusion catalyst 903 through valve 908. The cold side 911 of the thermoelectric plate may be cooled by ambient air or by a cooling heat transfer medium flowing past this surface. The partial pressure of the D₂, H₂, or combination thereof may be measured by a sensor or estimated from the voltage output of the thermoelectric device. Alternatively or in combination, the deuterium and/or hydrogen can be stored as a hydride in a hydride storage material and the partial pressure of the D₂, H₂, or a combination thereof may be controlled by heating this hydride. The battery may be recharged periodically by purging chamber 907 to remove products such as helium-3, helium-4, or other products and recharging with D₂, H₂, or a combination thereof. The battery may be coupled to a conventional electrochemical cell (e.g., a lead acid battery, a lithium ion battery) that is trickle-charged to be continuously recharged while connected to a load. For example, a battery can be connected to a load that uses bursts of electricity from the battery, and a fusion catalyst can supply a low amount of current to the battery to keep it charged. In this example, the presence of the battery can help mitigate the need to rapidly increase and decrease the fusion reaction during spikes in load intensity. At least one side of the thermoelectric generator may be coated with a semiconductor layer 910. The semiconductor layer 910 may convert the kinetic energy of the nuclear fusion products directly into electricity. The conversion of kinetic energy may be through an electron scattering mechanism, an ionization mechanism (e.g., a charged particle leaving a trail of excited electrons and/or holes generated by a transfer of the kinetic energy), or the like. For example, a charged helium nucleus generated in a fusion reaction with a kinetic energy of 1 MeV can generate a plurality of excited electron-hole pairs in a perovskite thin film via inelastic interactions with the film that can then be extracted as electricity.

### Computer Systems

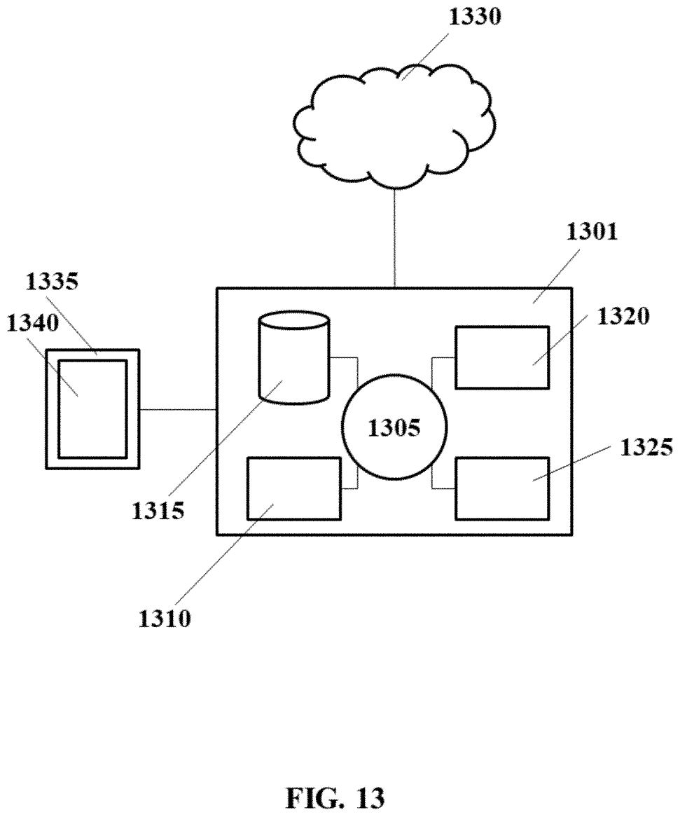

FIG. 13 shows a computer system 1301 that is programmed or otherwise configured to operate any method or system described herein (such as any method or system for nuclear fusion or any method or system for low-energy nuclear fusion described herein). The computer system 1301 can regulate various aspects of the present disclosure. The computer system 1301 can be an electronic device of a user or a computer system that is remotely located with respect to the electronic device. The electronic device can be a mobile electronic device.

The computer system 1301 includes a central processing unit (CPU, also “processor” and “computer processor” herein) 1305, which can be a single core or multi core processor, or a plurality of processors for parallel processing. The computer system 1301 also includes memory or memory location 1310 (e.g., random-access memory, read-only memory, flash memory), electronic storage unit 1315 (e.g., hard disk), communication interface 1320 (e.g., network adapter) for communicating with one or more other systems, and peripheral devices 1325, such as cache, other memory, data storage and/or electronic display adapters. The memory 1310, storage unit 1315, interface 1320 and peripheral devices 1325 are in communication with the CPU 1305 through a communication bus (solid lines), such as a motherboard. The storage unit 1315 can be a data storage unit (or data repository) for storing data. The computer system 1301 can be operatively coupled to a computer network (“network”) 1330 with the aid of the communication interface 1320. The network 1330 can be the Internet, an internet and/or extranet, or an intranet and/or extranet that is in communication with the Internet. The network 1330 in some cases is a telecommunication and/or data network. The network 1330 can include one or more computer servers, which can enable distributed computing, such as cloud computing. The network 1330, in some cases with the aid of the computer system 1301, can implement a peer-to-peer network, which may enable devices coupled to the computer system 1301 to behave as a client or a server.

The CPU 1305 can execute a sequence of machine-readable instructions, which can be embodied in a program or software. The instructions may be stored in a memory location, such as the memory 1310. The instructions can be directed to the CPU 1305, which can subsequently program or otherwise configure the CPU 1305 to implement methods of the present disclosure. Examples of operations performed by the CPU 1305 can include fetch, decode, execute, and writeback.

The CPU 1305 can be part of a circuit, such as an integrated circuit. One or more other components of the system 1301 can be included in the circuit. In some cases, the circuit is an application specific integrated circuit (ASIC).

The storage unit 1315 can store files, such as drivers, libraries, and saved programs. The storage unit 1315 can store user data, e.g., user preferences and user programs. The computer system 1301 in some cases can include one or more additional data storage units that are external to the computer system 1301, such as located on a remote server that is in communication with the computer system 1301 through an intranet or the Internet.

The computer system 1301 can communicate with one or more remote computer systems through the network 1330. For instance, the computer system 1301 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1301 via the network 1330.

Methods as described herein can be implemented by way of machine (e.g., computer processor) executable code stored on an electronic storage location of the computer system 1301, such as, for example, on the memory 1310 or electronic storage unit 1315. The machine executable or machine-readable code can be provided in the form of software. During use, the code can be executed by the processor 1305. In some cases, the code can be retrieved from the storage unit 1315 and stored on the memory 1310 for ready access by the processor 1305. In some situations, the electronic storage unit 1315 can be precluded, and machine-executable instructions are stored on memory 1310.

The code can be pre-compiled and configured for use with a machine having a processer adapted to execute the code or can be compiled during runtime. The code can be supplied in a programming language that can be selected to enable the code to execute in a pre-compiled or as-compiled fashion.

Aspects of the systems and methods provided herein, such as the computer system 1301, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 1301 can include or be in communication with an electronic display 1335 that comprises a user interface (UI) 1340. Examples of UI's include, without limitation, a graphical user interface (GUI) and web-based user interface,

Methods and systems of the present disclosure can be implemented by way of one or more algorithms. An algorithm can be implemented by way of software upon execution by the central processing unit 1305. The algorithm can, for example, direct the generation of power using energy from nuclear fusion or direct the generation of power using energy from low-energy nuclear fusion.

While preferred embodiments of the present invention have been shown and described herein, it will be obvious to those skilled in the art that such embodiments are provided by way of example only. It is not intended that the invention be limited by the specific examples provided within the specification. While the invention has been described with reference to the aforementioned specification, the descriptions and illustrations of the embodiments herein are not meant to be construed in a limiting sense. Numerous variations, changes, and substitutions will now occur to those skilled in the art without departing from the invention. Furthermore, it shall be understood that all aspects of the invention are not limited to the specific depictions, configurations or relative proportions set forth herein which depend upon a variety of conditions and variables. It should be understood that various alternatives to the embodiments of the invention described herein may be employed in practicing the invention. It is therefore contemplated that the invention shall also cover any such alternatives, modifications, variations, or equivalents. It is intended that the following claims define the scope of the invention and that methods and structures within the scope of these claims and their equivalents be covered thereby.

What is claimed is:

1. A method for nuclear fusion comprising:
a) providing a chamber comprising a host material having a fusionable material coupled thereto;
b) providing electromagnetic radiation to said fusionable material in said chamber to generate oscillations within said host material or said fusionable material, which oscillations are sufficient to subject said fusionable material to a nuclear fusion reaction to yield energy in said chamber; and
c) extracting at least a portion of said energy from said chamber.

2. The method of claim 1, wherein said host material comprises one or more members selected from the group consisting of a metal, a metal hydride, a metal carbide, a metal nitride, and a metal oxide.

3. The method of claim 1, wherein said host material comprises one or more particles comprising a characteristic dimension of at most about 1,000 nanometers (nm).

4. The method of claim 1, wherein said fusionable material comprises one or more members selected from the group consisting of hydrogen, deuterium, lithium, and boron.

5. The method of claim 1, wherein said oscillations comprise lattice oscillations of one or more members selected from the group consisting of said host material and said fusionable material.

6. The method of claim 5, wherein said lattice oscillations comprise coherent oscillations.

7. The method of claim 6, wherein said lattice oscillations persist for at least about one oscillation period.

8. The method of claim 6, wherein said coherent oscillations comprise phonon oscillations.

9. The method of claim 8, wherein said phonon oscillations comprise harmonic phonon oscillations.

10. The method of claim 8, wherein said phonon oscillations comprise parametric phonon oscillations.

11. The method of claim 6, wherein said coherent oscillations comprise non-linear phonon oscillations.

12. The method of claim 6, wherein said coherent oscillations comprise spatially localized oscillations.

13. The method of claim 1, wherein said electromagnetic radiation comprises one or more frequencies between 1 terahertz (THz) and 50 THz.

14. The method of claim 1, wherein said electromagnetic radiation comprises one or more frequencies corresponding to a fundamental, harmonic, or sub-harmonic lattice frequency or surface vibration frequency of said host material or said fusionable material or said fusionable material dissolved in said host material.

15. The method of claim 1, wherein said energy comprises one or more members selected from the group consisting of heat, kinetic energy of charged particles, coherent oscillations, and kinetic motion of charged product nuclei.

16. The method of claim 15, further comprising containing said host material within a heat transfer material configured to extract said heat.

17. The method of claim 16, wherein said heat transfer material comprises a thermal conductivity of at least about 1 Watt meters⁻¹ Kelvin⁻¹ (W m⁻¹ K⁻¹).

18. The method of claim 17, wherein said thermal conductivity is at least about 1000 W m⁻¹ K⁻¹.

19. The method of claim 16, wherein said heat transfer material comprises a material having a higher thermal conductivity region nearer to said host material and a lower thermal conductivity region further from said host material.

20. The method of claim 19, wherein said higher thermal conductivity region comprises a porous medium thermal conductivity material.

21. The method of claim 16, wherein said heat transfer material comprises one or more members selected from the group consisting of: carbon nanotubes (CNTs), single-walled CNTs, double-walled CNTs, multi-walled CNTs, graphite, graphene, diamond, zirconium oxide, aluminum oxide, and aluminum nitride.

22. The method of claim 16, further comprising containing said heat transfer material within a heat exchange fluid.

23. The method of claim 22, further comprising using said heat exchange fluid to drive a generator.

24. The method of claim 1, further comprising providing a system for generating temperature and pressure oscillations of said fusionable material in a gaseous form, which oscillations are sufficient to control a chemical activity at a surface of said host material.

25. A method for low-energy nuclear fusion, comprising:
a. catalytically inducing a low-energy nuclear fusion reaction in a fusionable material to yield energy; and
b. extracting at least a portion said energy.

26. The method of claim 25, wherein said low-energy nuclear fusion reaction comprises one or more intermediate reaction steps.

27. A system for nuclear fusion, comprising:
a. a chamber comprising a host material having a fusionable material coupled thereto;
b. a source of electromagnetic radiation configured to generate oscillations within said host material or said fusionable material, which oscillations are sufficient to subject said fusionable material to a nuclear fusion reaction to yield energy in said chamber; and
c. an energy extraction unit configured to extract at least a portion of said energy from said chamber.
